(19) United States
(12) Patent Application Publication
(10) Pub. No.: US 2022/0417780 A1
(43) Pub. Date: Dec. 29, 2022

(54) COLLECTION AND REPORTING OF QUALITY OF EXPERIENCE INFORMATION

(71) Applicant: ZTE Corporation, Shenzhen (CN)

(72) Inventors: Jing Liu, Shenzhen (CN); He Huang, Shenzhen (CN)

(21) Appl. No.: 17/895,463

(22) Filed: Aug. 25, 2022

Related U.S. Application Data
(63) Continuation of application No. PCT/CN2020/076905, filed on Feb. 27, 2020.

(51) Int. Cl. H04W 24/10; H04W 28/02

(52) U.S. Cl. CPC H04W 24/10; H04W 28/0268

(57) ABSTRACT

The present application relates to methods, systems, and devices related to digital wireless communication, and more specifically, to techniques related to for quality of experience (QoE) measurement collection. In one exemplary aspect, a method for wireless communication includes receiving, by a terminal, a first message from a network node that includes a configuration for collecting experience quality information. The method also includes transmitting, by the terminal, a second message to the network node including a set of experience quality information collected by the terminal and transmitted according to the configuration for collecting experience quality information received in the first message.

### CROSS REFERENCE TO RELATED APPLICATIONS

This patent document is a continuation of and claims benefit of priority to International Patent Application No. PCT/CN2020/076905, filed on Feb. 27, 2020. The entire content of the before-mentioned patent application is incorporated by reference as part of the disclosure of this application.

### TECHNICAL FIELD

This patent document is directed generally to wireless communications.

### BACKGROUND

Mobile communication technologies are moving the world toward an increasingly connected and networked society. The rapid growth of mobile communications and advances in technology have led to greater demand for capacity and connectivity. Other aspects, such as energy consumption, device cost, spectral efficiency, and latency are also important to meeting the needs of various communication scenarios. Various techniques, including new ways to provide higher quality of service, are being discussed.

### SUMMARY

This document discloses methods, systems, and devices related to digital wireless communication, and more specifically, to techniques related to for quality of experience (QoE) measurement collection.

In one exemplary aspect, a method for wireless communication is disclosed. The method includes receiving, by a terminal, a first message from a network node that includes a configuration for collecting experience quality information. The method also includes transmitting, by the terminal, a second message to the network node including a set of experience quality information collected by the terminal and transmitted according to the configuration for collecting experience quality information received in the first message.

In another exemplary aspect, a method for wireless communication is disclosed. The method includes transmitting, by a network node, a first message to a terminal that includes a configuration for collecting experience quality information. The method also includes receiving, by the network node, a second message from the terminal that includes a set of experience quality information collected by the terminal that is transmitted according to the configuration for collecting experience quality information received in the first message.

In another exemplary aspect, a wireless communications apparatus comprising a processor is disclosed. The processor is configured to implement a method described herein.

In yet another exemplary aspect, the various techniques described herein may be embodied as processor-executable code and stored on a computer-readable program medium.

Some embodiments may preferably implement the following solutions, written in a clause-format.

1. A solution for wireless communication, comprising: receiving, by a terminal, a first message from a network node that includes a configuration for collecting experience quality information; and transmitting, by the terminal, a second message to the network node including a set of experience quality information collected by the terminal and transmitted according to the configuration for collecting experience quality information received in the first message.

2. The solution of clause 1, further comprising: collecting, by the terminal, the set of experience quality information.

3. The solution of clause 1, wherein any of the configuration for collecting experience quality information included in the first message or the collected set of experience quality information included in the second message includes quality of service (QoS) information.

4. The solution of clause 3, wherein the QoS information includes any of QoS Flow identifier (QFI), protocol data unit (PDU) session identifier, Evolved Universal Terrestrial Access Network (E-UTRAN) Radio Access Bearer identifier (E-RAB ID), and QoS profile information.

5. The solution of clause 1, wherein any of the configuration for collecting experience quality information included in the first message or the collected set of experience quality information included in the second message includes network slice identifier.

6. The solution of clause 1, wherein any of the configuration for collecting experience quality information included in the first message or the collected set of experience quality information included in the second message includes information identifying target radio access technology (RAT) in which to collect the set of experience quality information.

7. The solution of clause 6, wherein the information identifying the target RAT includes any of a cell identity list of at least one RAT or a tracking area code list of at least one RAT or RAT type.

8. The solution of clause 1, wherein any of the configuration for collecting experience quality information included in the first message or the collected set of experience quality information included in the second message includes node information that is indicative of target node in which to collect the set of experience quality information.

9. The solution of clause 1, wherein any of the configuration for collecting experience quality information included in the first message and the collected set of experience quality information included in the second message includes bearer type indicator indicative of target bearer type for collecting the set of experience quality information.

10. The solution of clause 9, wherein the bearer type indicator can be indicative of any of a master cell group (MCG) bearer, a secondary cell group (SCG) bearer, a split bearer, a master node (MN) terminated MCG bearer, a MN terminated SCG bearer, a MN terminated split bearer, a secondary node (SN) terminated MCG bearer, a SN terminated SCG bearer, or a SN terminated split bearer.

11. The solution of clause 1, wherein the configuration for collecting experience quality information includes a number of application configuration containers, wherein each application configuration container is applied to a specific RAT.

12. The solution of clause 2, wherein collecting the set of experience quality information includes logging a bearer type and time stamp information of the collected service according to the configuration for collecting experience quality information.

13. The solution of clause 1, further comprising: receiving, by the terminal, multiple configurations for measuring experience quality information from each of a master node (MN) and a secondary node (SN); measuring, by the terminal, a first set of experience quality information when bearer is established over master cell group (MCG) radio interface and a second set of experience quality information when bearer is established over a secondary cell group (SCG) radio interface; and transmitting, by the terminal, a first report to the MN that includes the first set of experience quality information and a second report to the SN that includes the second set of experience quality information.

14. The solution of clause 1, wherein the second message is transmitted responsive to the terminal measuring the set of experience quality information.

15. The solution of clause 1, further comprising: transmitting, by the terminal, an experience quality information indication to the network node indicating that the terminal has collected the set of experience quality information; and receiving, by the terminal, an experience quality information response from the network node, wherein the second message is transmitted by the terminal responsive to receiving the experience quality information response from the network node.

16. The solution of clause 1, further comprising: transmitting, by the terminal, a 1-bit experience quality information results available indication to the network node indicating that the terminal has measured the set of experience quality information.

17. The solution of clause 16, wherein the 1-bit experience quality information results available indication is transmitted to the network node via any of a radio resource control (RRC) reconfiguration complete message, a terminal assistance information message, a RRC setup complete message, and a RRC resume complete message.

18. The solution of any of clauses 16 and 17, further comprising: receiving, by the terminal, an RRC message from the network node that includes a request for the set of experience quality information when a network load is below a threshold level, wherein the terminal transmits the second message to the network node responsive to receiving the RRC message from the network node.

19. The solution of clause 1, further comprising: receiving, by the terminal, a suspension indication from the network node that includes an indication for the terminal to suspend transmission of the second message and/or stop measuring the set of experience quality information.

20. The solution of clause 20, further comprising: receiving, by the terminal, a resume indication from the network node, wherein the second message is transmitted by the terminal responsive to receiving the resume indication from the network node.

21. The solution of clause 19, further comprising: initiating, by the terminal, a timer with a duration indicated in the suspension indication either upon reception of the suspension indication or upon completion of collection of the set of experience quality information; and releasing, by the terminal, the set of experience quality information collected by the terminal when the timer expires.

22. The solution of any of clauses 1 and 19, further comprising: determining, by the terminal, that a power consumption level of the terminal exceeds a threshold power level; and responsive to determining that the power consumption level of the terminal exceeds the threshold power level, transmitting, by the terminal, a power saving message to the network node to initiate a power saving operation, wherein the suspension indication is received by the terminal responsive to transmission of the power saving message.

23. A solution for wireless communication, comprising: transmitting, by a network node, a first message to a terminal that includes a configuration for collecting experience quality information; and receiving, by the network node, a second message from the terminal that includes a set of experience quality information collected by the terminal that is transmitted according to the configuration for collecting experience quality information received in the first message.

24. The solution of clause 23, further comprising: receiving, by the network node, the configuration for collecting experience quality information from a core network node or operation and maintenance (OAM) entity.

25. The solution of any of clauses 23 and 24, further comprising: forwarding, by the network node, the second message to a QoE collection node.

26. The solution of any of clauses 24 and 25, wherein the core network node includes any of a Core Access and Mobility Management Function (AMF) node and a Mobility Management Entity (MME) node.

27. The solution of clause 23, further comprising: forwarding, by the network node, the configuration for collecting experience quality information to a secondary network node, wherein the secondary network node is configured to modify and/or transmit the configuration for collecting experience quality information to the terminal.

28. The solution of clause 23, wherein the network node includes a central unit (CU), and wherein the network node transmits the configuration for collecting experience quality information to a distributed unit (CU), wherein the configuration for collecting experience quality information includes any of a requested service type for the set of experience quality information, dedicated radio bearer (DRB) information for the requested service type, and an indication to start, stop, or suspend measuring the set of experience quality information by the terminal.

29. The solution of clause 23, further comprising: receiving, by the network node, a configuration indication from a secondary network node of whether the network node is capable of configuring the configuration for collecting experience quality information to the terminal.

30. The solution of clause 29, wherein the configuration indication is received by the network node responsive to the secondary network node determining that the terminal supports experience quality information measurement and reporting over a radio access technology (RAT) associated with the secondary network node.

31. The solution of clause 29, wherein the configuration indication is received by the network node responsive to the secondary network node supporting experience quality information measurement and reporting toward the terminal.

32. The solution any of clause 23 and clause 24, wherein any of the configuration for collecting experience quality information included in the first message and the measured set of experience quality information included in the second message and the configuration for collecting experience quality information from a core network node includes any of quality of service (QoS) information, a network slice selection identifier, information identifying a target radio access technology (RAT) in which to measure the set of experience quality information, node information that is indicative of a target node in which to measure the set of experience quality information, and a bearer type indicator indicative of a target bearer type in which to measure the set of experience quality information.

33. The solution of clause 23, further comprising: transmitting, by the network node, one of multiple configurations for measuring experience quality information to the terminal; and receiving, by the network node, a first report from the terminal that includes a first set of experience quality information measured by the terminal when the bearer is established over a master cell group (MCG) radio interface; and receiving, by the network node, a second report from the terminal that includes a second set of experience quality information measured by the terminal when the bearer is established over a secondary cell group (SCG) radio interface.

34. The solution of clause 23, further comprising: receiving, by the network node, an experience quality information indication from the terminal indicating that the terminal has measured the set of experience quality information; and transmitting, by the network node, an experience quality information response to the terminal, wherein the second message is transmitted by the terminal responsive to receiving the experience quality information response from the network node.

35. The solution of clause 23, further comprising: receiving, by the network node, a 1-bit experience quality information results available indication from the terminal indicating that the terminal has measured the set of experience quality information.

36. The solution of clause 35, wherein the 1-bit experience quality information results available indication received by the network node via any of a radio resource control (RRC) reconfiguration complete message, a terminal assistance information message, a RRC setup complete message, and a RRC resume complete message.

37. The solution of any of clauses 35 and 36, further comprising: transmitting, by the network node, an RRC message to the terminal that includes a request for the set of experience quality information when a network load is below a threshold level, wherein the terminal transmits the second message to the network node responsive to receiving the RRC message from the network node.

38. The solution of clause 23, further comprising: transmitting, by the network node, a suspension indication to the terminal that includes an indication for the terminal to suspend transmission of the second message and/or stop measuring the set of experience quality information.

39. The solution of clause 38, further comprising: transmitting, by the network node, a resume indication to the terminal, wherein the second message is transmitted by the terminal responsive to receiving the resume indication from the network node.

40. The solution of any of clauses 23 and 39, further comprising: receiving, by the network node, a power saving message from the terminal to initiate a power saving operation responsive to the terminal determining that a power consumption level of the terminal exceeds a threshold power level, wherein the suspension indication is received by the terminal responsive to transmission of the power saving message.

41. An apparatus for wireless communication comprising a processor that is configured to carry out the solution of any of clauses 1 to 40.

42. A non-transitory computer readable medium having code stored thereon, the code when executed by a processor, causing the processor to implement a solution recited in any of clauses 1 to 40.

The details of one or more implementations are set forth in the accompanying attachments, the drawings, and the description below. Other features will be apparent from the description and drawings, and from the clauses.

### BRIEF DESCRIPTION OF THE DRAWINGS

FIG. 1 is an example signaling process for signaling based QoE measurement.

FIG. 2 is an example signaling process for management based QoE measurement.

FIG. 3 is an example signaling process for QoE measurement configuration for a MR-DC UE.

FIG. 4 is an example signaling process for QoE measurement reporting for MR-DC UEs.

FIG. 5 is an example signaling process for a SN QoE measurement capable indication.

FIG. 6 is an example signaling process for a SN QoE measurement permission indication.

FIG. 7 is a block diagram of an example method for quality of experience (QoE) measurement collection.

FIG. 8 shows an example of a wireless communication system where techniques in accordance with one or more embodiments of the present technology can be applied.

FIG. 9 is a block diagram representation of a portion of a hardware platform.

### DETAILED DESCRIPTION

The development of the new generation of wireless communication—5G New Radio (NR) communication—is a part of a continuous mobile broadband evolution process to meet the requirements of increasing network demand. NR will provide greater throughput to allow more users connected at the same time. Other aspects, such as energy consumption, device cost, spectral efficiency, and latency are also important to meeting the needs of various communication scenarios.

In various wireless communication systems, a quality of experience (QoE) measurement collection framework can support multiple triggering scenarios. Examples of such scenarios can include a signaling based QoE measurement and a management based QoE measurement.

For Signaling based QoE measurement, the core-network can trigger QoE collection towards a specific UE, and the core-network can deliver the QoE measurement configuration to the network via UE specific signaling. For Management based QoE measurement, an operations, administration, and management (OAM) node can deliver QoE collection mission to radio access network (RAN) node, and the RAN node can select one or more suitable UEs to perform QoE measurement collection and reporting.

Additionally, the UE can inform network whether it supports QoE measurement collection. More specifically, the UE can indicate separate capabilities for streaming service and Multimedia Telephony Service for IP multimedia subsystem (IMS) (MTSI) service. Moreover, the network can deliver UE's QoE capability to core network such that the core network can rely on a UE capability together with RAN node's QoE capability and decide whether to trigger signaling based QoE measurement towards this UE.

For both signaling based QoE measurement and management based QoE measurement, the network can deliver the QoE measurement configuration to UE. This can include an application layer QoE measurement configuration container and requested service type. The UE's application layer can collect and log the experience information based on the configuration and send QoE measurement report to network. The report can include a QoE measurement report container and service type. The network can then deliver UE's QoE report to a collection center.

In many cellular mobile communication systems, the network can provide various services for users, such as streaming service, voice/video call, interactive gaming, AR/VR, etc. Each kind of service can be standardized with Quality of Service (QoS) requirements, such as a packet delay budget, packet error rate, latency, etc. However, due to various types of services and various types of users, the service requirements may not be enough to provide good user experience for all users. Therefore, network resources may be designed and optimized in order to provide better service experiences for users.

In many systems, QoE measurement collection mechanism is introduced. The main purpose of QoE measurement is to collect a UE's experience information for specific service types at the application layer. The collected information can be transported from UE to network or collection center for further analysis. In a 5G NR system, a similar approach will be introduced. However, considering the new QoS framework and characteristics of 5G system, many aspects may need to be further studied for QoE measurement in 5G system.

A first aspect may include, in a NR system, for a given service type (e.g., streaming, VR, etc.), it may have different QoS profiles for different users (e.g. Ultra Reliable Low Latency Communications (URLLC), Enhanced Mobile Broadband (eMBB), Vehicle, etc.). From a network perspective, if only the service type is indicated in QoE measurement configuration, it can be difficult to optimize the network for a specific user group. In addition, NR system can support network slice, which allows for differentiated treatment depending on requirements for a customer. Therefore, for QoE measurement in NR system, network slice should also be taken into consideration, so that operators can collect user experience for a given slice.

In a second aspect, different from various wireless communication systems, a 5G NR system may have higher power consumption of both UE and network sides. This may become particularly important in a wide deployment of a 5G network. Moreover, due to widespread usage of a 5G system, a number of connecting users can be extremely high. So, in a case when a network is overloaded, the network may want to suspend the ongoing QoE measurement and resume until network load is reduced. On the other hand, the UE may also want to stop/suspend the ongoing QoE measurement when UE encounter overheating problem. These are not supported in exiting QoE measurement mechanisms.

In a third aspect, in addition to NR standalone UEs, a 5G system can also support Multi-Radio Dual Connectivity (MR-DC) operation. In this case, the UE can connect to two nodes, where one node acts as the Master Node (MN) and the other acts as the Secondary Node (SN). MN and SN can belong to the same RAT (e.g. NR-DC), or they can belong to different RATs (e.g. E-UTRAN New Radio—Dual Connectivity (EN-DC), NR—E-UTRA Dual Connectivity (NE-DC), NG-RAN—E-UTRA Dual Connectivity (NGEN-DC)). However, there is no solution for QoE measurement for MR-DC UEs. Accordingly, in many cases, QoE information cannot be collected for MR-DC UEs.

System Overview

The present application relates to techniques that can be implemented for QoE measurement collection. In some embodiments, the MN can be an eNB, a ng-eNB, or a gNB, and the SN can be a eNB, a ng-eNB, or a gNB. In the present application, the “RAN node” can also be referred to as a “network,” and it can be a eNB, a ng-eNB, or a gNB.

For a QoE measurement configuration, the QoE measurement configuration can include any of QoS information, network slice information, RAT information, Node information, and bearer type information. For MR-DC UE, the network can determine bearer type of requested service based on the RAT/Node information or bearer type received in QoE configuration.

For MR-DC UE, the MN can forward the QoE measurement configuration to SN. For a CU-DU split, the CU can inform DU about the configured QoE measurement, which can include any of a service type, a dedicated radio bearer (DRB) ID, and start/stop/suspend/resume indication for QoE measurement.

For QoE measurement logging, a UE can log the bearer type and time stamp information for requested service, where this information can be included in a QoE measurement report sent to network. The network can log the bearer type and time stamp information for requested service and includes this information together with UE's QoE measurement report and send it to a collection node. For MR-DC UE, the UE can depend on bearer type to record two separate QoE log and send it to MN and SN separately.

For QoE measurement reporting, a QoE report can include QoS information, network slice information, and/or bearer type and time stamp information. The UE can send QoE results available indication to network, and the network can obtain the QoE report via independent procedure. A SN can forward UE's QoE report to a MN. The MN can forward QoE results to SN, and the CU can forward QoE results to DU.

For QoE capability negotiation, a SN can inform MN about the capable of QoE measurement configuration/reporting over the SN. MN can inform SN whether SN is allowed to configure QoE measurement towards UE. MN and SN can exchange the configured QoE measurement information.

For consideration on power saving and network overload, a network can send QoE suspension/resume indication to UE. The network can send timer value to UE, used to provide the validity time of QoE results collected by UE. The UE can send indication to network, ask network to suspend, or stop QoE measurement. During intra-RAT handover, source cell can forward the QoE measurement configuration to target cell. During inter-RAT or inter-system handover, the UE can stop the QoE measurement locally.

QoE Measurement Configuration

For QoE measurement collection activation, the core network (e.g., access and management function (AMF), MME, OAM) can transmit QoE measurement configuration to RAN node (e.g., gNB, ng-eNB, eNB). For each QoE collection mission, besides requested service type and application configuration container, the QoE measurement configuration can include one or more parameters.

A parameter can include QoS information. QoS information can include any of a QoS flow identifier (QFI), a PDU session ID, an E-RAB ID, QoS profile information (e.g., 5QI, ARP), a service type ID, etc.

A parameter can include network slice information (e.g., a single network slice selection assistance information (S-NSSAI) identifier.

A parameter can include RAT information. RAT information can be used to indicate a target RAT that the QoE information is expected to be collected. A value included in the RAT information can include an indicator of a communication system type (e.g., LTE only, NR only, both), a cell list of one RAT or multiple RATs, a tracking area code list of one RAT, or multiple RATs, etc.

A parameter can include node information that can be used to indicate the target node that QoE information is expected to be collected. A value for the node information can include a value indicative of a MN only, a SN only, both MN and SN, etc.

A parameter can include bearer type that can be used to indicate the target bearer type that QoE information is expected to be collected. The bearer type can be a MCG bearer, SCG bearer, Split bearer, MN terminated MCG bearer, MN terminated SCG bearer, MN terminated split bearer, SN terminated MCG bearer, SN terminated SCG bearer, SN terminated split bearer, etc. The expected bearer type can also be the combination of bearer types.

In some events, a core network node or OAM can activate multiple QoE measurement missions. In this event, each QoE measurement mission can be identified by an identifier, the identifier can be allocated by core network or OAM and included in the QoE measurement configuration transmitted to RAN node. In some embodiments, the identifier can be allocated by RAN node and included in QoE measurement configuration transmitted to the UE.

In some embodiments, the core network, OAM or gNB can dynamically add, modify, or release one or more of QoE measurement missions.

In some embodiments, for MR-DC UE, a QoE measurement configuration sent from core network or OAM may include multiple application configuration containers, where each container can apply to a specific RAT.

Upon reception of QoE measurement configuration from core network or OAM, the RAN node can transmit the QoE measurement configuration to UE via a Uu interface. The QoE measurement configuration may include above QoS information, network slice information, RAT information, and/or node information, bearer type information.

In some embodiments, if the UE is a MR-DC UE, after the MN receives the QoE measurement configuration from core network or OAM, the MN can forward the QoE configuration to SN. The SN can then transmit the QoE measurement configuration to UE.

In some embodiments, the MN may forward the QoE configuration to SN when the MN receives RAT information that indicates the SN's RAT or both the MN and SN or when the MN receives Node information indicates the SN or both the MN and SN.

In some embodiments, for MR-DC UE, upon reception the QoE configuration, the RAN node (i.e. MN and/or SN) can determine the bearer type of requested service, which can be done based on the information indicated in QoE configuration. The bearer type can include one of a MN terminated MCG bearer, a MN terminated SCG bearer, a MN terminated split bearer, a SN terminated MCG bearer, a SN terminated SCG bearer, a SN terminated split bearer, etc.

In some embodiments, for a CU-DU split scenario, when a RAN node configures QoE measurement towards UE, the CU can provide the DU with various information. Such information can include the requested service type for QoE measurement, the DRB information of requested service type, such as DRB identifier, the start, or stop, or suspend, or resume indication for QoE measurement, etc.

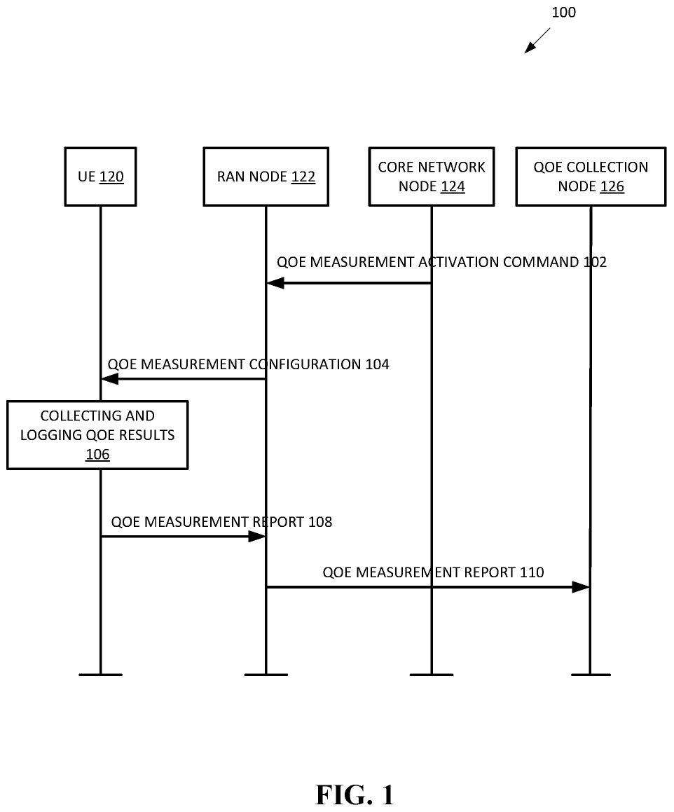

FIG. 1 is an example signaling process 100 for signaling based QoE measurement. A core network node 124 can send a QoE measurement activation command 102 to a RAN node. The QoE measurement activation command 102 can include QoE measurement configuration, IP address of a QoE collection node, etc.

The RAN node 122 can send the QoE measurement configuration 104 to the UE 120. The UE can perform collection and logging of QoE results 106. The UE 120 can send a QoE measurement report 108 to the RAN node 122. The RAN node 122 can send the QoE measurement report 110 to a QoE collection node.

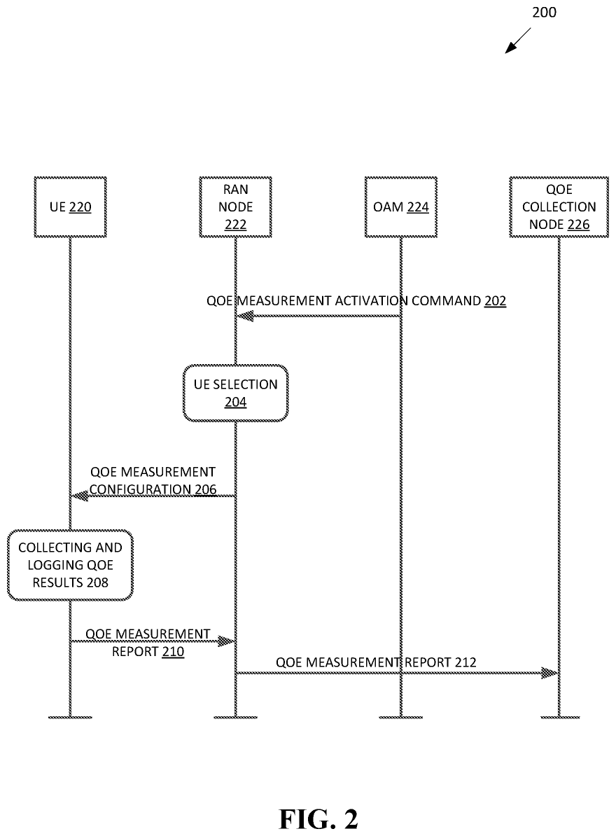

FIG. 2 is an example signaling process 200 for management based QoE measurement. The OAM 224 can send a QoE measurement activation command 202 to a RAN node 222. The QoE measurement activation command 202 can include QoE measurement configuration, IP address of a QoE collection node, etc.

The RAN node 222 can perform UE selection 204. The RAN node 222 can send the QoE measurement configuration 206 to the UE 220. The UE 220 can perform collection and logging of QoE results 208. The UE 220 can send a QoE measurement report 210 to the RAN node 222. The RAN node 222 can send the QoE measurement report 212 to a QoE collection node.

### Example 1

In a first example, with a NR standalone (SA) UE in RRC CONNECTED mode, the core network (i.e. AMF) can trigger signaling based QoE measurement for this UE, where the requested service type can include a streaming service. The AMF can then send the QoE measurement activation command to gNB that includes a QoE measurement configuration container, service type equal to streaming, a QFI equal to 2, and a 5QI equal to 6.

Upon receiving the QoE command, the gNB can generate the QoE measurement configuration message and send it to UE. The measurement configuration can include the QoE measurement configuration container, service type equal to streaming, QFI equal to 2, 5QI equal to 6. Moreover, when gNB establish the corresponding radio bearer (e.g. DRB ID equal to 3) for this QoS flow, the gNB-CU can also indicate the gNB-DU that the UE is configured with QoE measurement for streaming service, and the corresponding DRB ID can be 3. Based on this information, the gNB-DU can prioritize the scheduling for this DRB.

### Example 2

In a second example, a OAM triggers management based QoE measurement to the serving cell, where the requested service type is streaming service. The OAM can then send QoE a measurement activation command to gNB that includes QoE measurement configuration container, service type equal to streaming, and S-NSSAI equal to 5.

Upon receiving the QoE command, the gNB can first select the suitable UE based on the received S-NSSAI. The gNB can then select a UE1, which is operating on NR SA mode, and the UE's registered S-NSSAI equals 5. Then, the gNB can generate the QoE measurement configuration message and sends it to UE, the measurement configuration including the QoE measurement configuration container, and service type equal to streaming.

### Example 3

In a third example, a EN-DC UE is connected to both eNB (MN) and gNB (SN), the core network (i.e. MME) triggers signaling based QoE measurement for this UE, the request service type is VR, and the core network only wants to collect the experience information over NR RAT. The MME can send QoE measurement activation command to MN that includes QoE measurement configuration container, service type equal to VR, and RAT information equal to NR, or Node information equal to SN, or Bearer Type equal to SN terminated SCG bearer.

Upon receiving the QoE command, the MN can generate the QoE measurement configuration message and send it to UE, the measurement configuration including the QoE measurement configuration container, service type equal to VR. Meanwhile, when establishing this service, the network can establish a bearer with bearer type equals SN terminated SCG bearer. Accordingly, the downlink and uplink transmission of this service can pass a SN radio interface (i.e. NR RAT).

In some instances, the MN may forward the QoE measurement configuration to SN, then the SN CU can inform SN DU to take appropriate scheduling optimization.

### Example 4

In a fourth example, a EN-DC UE is connected to both eNB (MN) and gNB (SN), the core network (i.e. MME) triggers signaling based QoE measurement for this UE, the request service type is VR, and the core network only wants to collect the experience information over both MN's RAT and SN's RAT. The MME can send QoE measurement activation command to MN, which can include QoE measurement configuration container, service type equal to VR, and RAT information equal to both or Node information equal to both.

Upon receiving the QoE command, the MN can forward the QoE measurement configuration to SN, both MN and SN generate the QoE measurement configuration message and send them to UE. The measurement configuration can include the QoE measurement configuration container, service type equal to VR, and RAT information equal to both or Node information equal to both.

In addition, for both MN and SN, its CU can inform its DU about the QoE measurement information, then the DU can take appropriate scheduling optimization.

### Example 5

In a fifth example, a NR SA UE can be connected to gNB, the core network (i.e. AMF) triggers first QoE measurement activation procedure, the request service type is VR. The AMF can send QoE measurement activation command to gNB, which includes QoE application configuration container, service type equal to VR, QoE mission ID equal to 1.

Upon receiving the QoE command, the gNB can generate the QoE measurement configuration message and send to UE. The measurement configuration can include the QoE application configuration container, service type equal to VR, and QoE mission ID equal to 1.

After a while, the AMF can trigger a second measurement activation procedure, the request service type is streaming. Moreover, the AMF can decide to delete the first QoE measurement for VR service. The AMF can send another QoE measurement activation command to gNB, includes QoE application configuration container (for streaming service), service type equal to streaming, QoE mission ID equal to 2, and a deletion list with one entry of QoE mission ID equal to 1.

Upon receiving this QoE command, the gNB can generate another QoE measurement configuration message and send to UE. The measurement configuration can include the QoE configuration container (for streaming service), service type equal to streaming, QoE mission ID equal to 2, and a deletion list with one entry of QoE mission ID equal to 1.

Upon reception of this QoE measurement configuration, the UE can stop the QoE collection of VR service, and starts the QoE collection for streaming service.

QoE Measurement Logging

From the perspective of a UE, upon reception the QoE measurement configuration from a RAN node, the UE can log experience information for the indicated service type. Moreover, the UE can record the bearer type, time stamp information together with QoE measurement results. The UE can deliver bearer type and time stamp information to network in a QoE measurement report.

The bearer type and time stamp information can express the bearer type of a collected service until the service is released. In some embodiments, the network can record the bearer type and time stamp information for the request service. After receiving the QoE measurement report from UE, the network can deliver the bearer type and time stamp information together with UE's QoE measurement report to a collection node.

In some embodiments, the UE or RAN node may only record the bearer type and time stamp information when “RAT information” is set to “both,” or “Node information” is set to “both.”

In some embodiments, for a given service, if both MN and SN configures QoE measurement to UE simultaneously, the UE can log the QoE results when the bearer is established over MCG radio interface, and log QoE results when the bearer is established over SCG radio interface. The UE can deliver separate QoE reports to MN and SN.

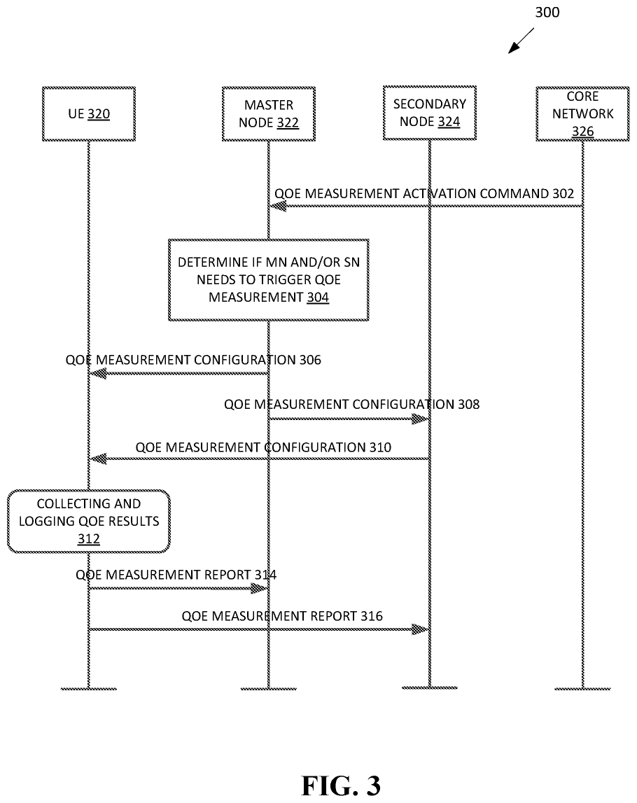

FIG. 3 is an example signaling process 300 for QoE measurement configuration for a MR-DC UE. A core network node 326 can send a QoE measurement activation command 302 to a master node (MN) 322. The MN 322 can determine if the MN and/or a SN 324 needs to trigger QoE measurement 304. The MN can send a QoE measurement configuration 306 to the UE 320. The MN 324 can also send a QUE measurement configuration 308 to the SN 322, and the SN can modify the configuration and/or forward the configuration 312 to the UE 320.

The UE 320 can perform collection and logging of QoE results 312. The UE 320 can send the QoE measurement report 314 to the MN 322. The UE can send the QoE measurement report 316 to the SN 324.

### Example 1

In a first example, a EN-DC UE can be connected to both eNB (MN) and gNB (SN). The UE can receive QoE measurement configuration from MN, which includes QoE measurement configuration container, service type=VR, and RAT information=both or Node information=both.

During UE logging the QoE experience information, the UE can also record the bearer type for this service. Since a network may change the bearer type dynamically, the bearer type can be recorded together with time stamp. The time stamp can be an absolute time or relative time.

For example: a first record can include a MCG bearer with master key with a time from 03:10:20 to 03:11:05. A second record can include a SCG bearer with secondary key with a time from 03:11:06 to 03:15:30. A third record can include a SCG bearer with master key with a time from 03:15:31 to 03:17:48.

When the UE sends the QoE measurement report to network, the UE can include the above bearer type information together with time stamp in QoE measurement report.

### Example 2

In a second example, an EN-DC UE is connected to both eNB (MN) and gNB (SN). The UE can receive QoE measurement configuration from MN, which can include QoE measurement configuration container, service type=VR, and RAT information=both or Node information=both.

During UE logging the QoE experience information, the MN can record the bearer type for this service, since network may change the bearer type dynamically, the bearer type is recorded together with time stamp. The time stamp can be absolute time or relative time. For example, a first record can include an MCG bearer with master key with a time from 03:10:20 to 03:11:05. A second record can include a SCG bearer with secondary key with a time from 03:11:06 to 03:15:30. A third record can include a SCG bearer with master key with a time from 03:15:31 to 03:17:48.

After receiving the QoE measurement report sent from UE, the MN can include the above bearer type information together with time stamp with UE's QoE measurement report and sent to a collection node.

### Example 3

In a third example, an EN-DC UE is connected to both eNB (MN) and gNB (SN). The UE can receive QoE measurement configuration from both MN and SN, which can include QoE measurement configuration container, service type=VR.

Since the UE receives QoE measurement configuration from both nodes, the UE can log the QoE experience separately. More specifically, the UE can generate two separate QoE log reports, where the first log report can include the experience information when VR service is established as MCG bearer or split bearer. The second log report can include the experience information when VR service is established as SCG bearer or split bearer. The UE can deliver the first log report to MN via QoE measurement report sent to MN and deliver the secondary one to SN via QoE measurement report sent to SN.

QoE Measurement Reporting

A QoE measurement report can be sent from UE to network node, and the QoE measurement report sent from the network node to collection node. The QoE measurement report can include experience information as well as any other information. Examples of such other information can include QoS information (e.g., QFI, E-RAB ID; QoS profile information (e.g., 5QI, ARP)), network slice information (e.g., S-NSSAI identifier), a bearer type of a logged service, etc. A bearer type of logged service can be transmitted together with time stamp information. The bearer type can include any of a MCG bearer, SCG bearer, split bearer, etc.

In some embodiments, the content of QoE measurement report from UE to network can be different from the content of QoE measurement report from network to collection node.

For QoE measurement reporting from UE to network, the UE can send QoE measurement report. This may include the UE sending the QoE measurement report to network directly when results are available at UE side. This may also include the UE first sending an available indication to network, indicating that UE has available QoE measurement results. The network can trigger a results retrieve procedure by sending a request to UE, then UE can deliver the QoE measurement report to network.

In some embodiments, for MR-DC UE, in case the QoE measurement configuration is configured by SN, after receiving the QoE measurement report from UE, the SN can deliver the report directly to collection node, or the SN can forward the report to MN, and MN can then deliver the QoE report to collection node.

In some embodiments, for MR-DC UE, in case the MN receives the QoE measurement report from UE, the MN can forward the QoE measurement results to SN side. The forwarded results can be the entire QoE measurement report, a 1-bit indication to indicate whether the UE satisfy the current QoE/latency, or an explicit assistant information for scheduling optimization.

In some embodiments, in case of CU-DU split, when network receives QoE measurement report from UE, the CU can forward the QoE measurement results to DU. The forwarded results can be entire QoE measurement report, a 1-bit indication to indicate whether the UE satisfy the current QoE/latency, or an explicit assistant information for scheduling optimization.

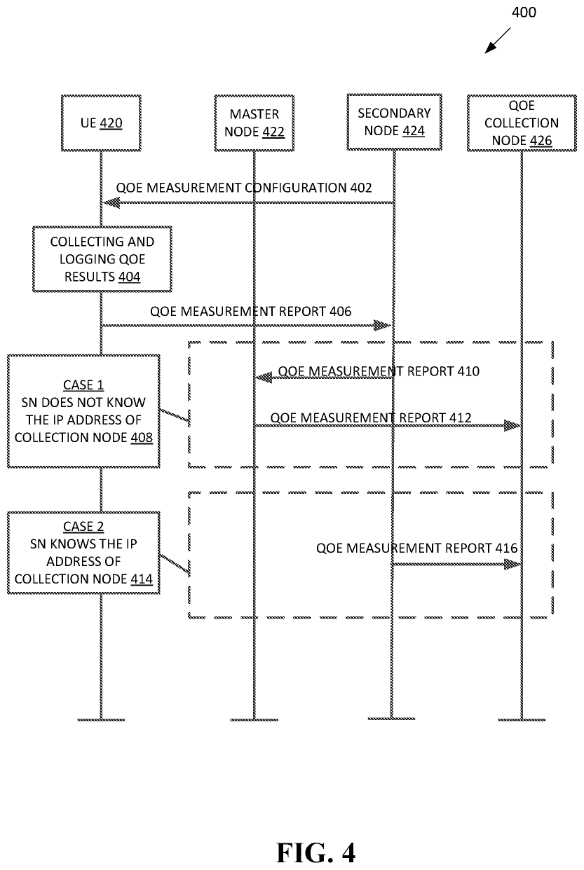

FIG. 4 is an example signaling process 400 for QoE measurement reporting for MR-DC UEs. The SN 424 can send a QoE measurement configuration 402 to the UE 420. The UE can perform collection and logging of QoE results 404. The UE can send the QoE measurement report 406 to the SN.

In a first case 408, the SN may not know the IP address of the collection node. In this case, the SN can send a QoE measurement report 410 to the MN 422. The MN can forward the QoE measurement report 412 to the QoE collection node 426.

In a second case 414, the SN knows the IP address of the collection node and sends the QoE measurement report 416 to the QoE collection node 426.

### Example 1

In a first example, a NR SA UE can be connected to gNB, and the UE can be configured with QoE measurement. When the UE already has available QoE measurement results, the UE can first send the 1-bit QoE results available indication to network. This available indication can be included in one of following RRC messages, or a newly defined RRC message, such as an RRC Reconfiguration Complete message, a UE assistance information message, a RRC Setup Complete message, a RRC Resume Complete message, etc.

After the network node receives the available indication from UE, the network node can trigger QoE retrieve procedure when network load is low. The network node can send an RRC message to UE to obtain the stored QoE report. The RRC message can be UE Information Request message, or a newly defined RRC message. Within this RRC message, the network can include an indication for QoE obtaining. Then, the UE can send QoE measurement report to the network node.

### Example 2

In a second example, a EN-DC UE is connected to both eNB (MN) and gNB (SN), the core network (i.e. MME) triggers signaling based QoE measurement for this UE. Upon receiving the QoE command, the MN can forward the QoE measurement configuration to SN, the QoE command can also include the IP address of the collection node. Then, the SN can generate the QoE measurement configuration message and send it to UE.

Since the QoE measurement is configured by SN, the UE can deliver the QoE measurement report to SN. After SN receives the QoE measurement report from UE, SN can identify that the SN node has no connection with the collection node (e.g. unknown IP address). The SN can forward the UE's QoE measurement report to MN, and MN can forward the report to the collection node.

QoE Capability Negotiation

For a MR-DC UE, the SN can inform the MN of whether SN is able to configure QoE measurement towards the UE. The SN may indicate the capable of QoE measurement when following a condition is fulfilled.

A first condition can include the UE supporting QoE measurement and reporting over the SN's RAT. A second condition can include the SN node supporting QoE measurement and reporting towards the UE.

In some embodiments, SN can inform MN the QoE measurement capability at a per service type level, or per network slice level, per UE level, per node level, etc.

In some embodiments, the SN QoE measurement capability can be transmitted in inter-node RRC message (e.g., CG-Config) or indicated by parameters in Xn/X2 messages.

In addition, upon SN addition, SN modification or SN change, the MN can inform SN whether the SN is allowed to configure QoE measurement towards UE.

In some embodiments, for management based QoE measurement, when MN triggers QoE measurement towards UE, the MN can inform SN about the on-going QoE measurement configuration and corresponding service type. Similarly, in case the SN triggers QoE measurement towards UE, the SN can inform MN about the on-going QoE measurement configuration and corresponding service type.

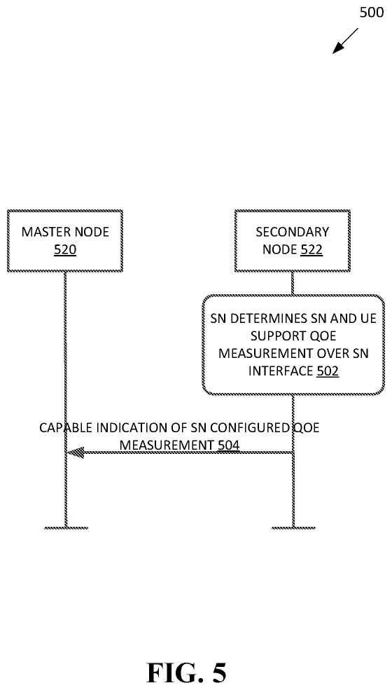

FIG. 5 is an example signaling process 500 for a SN QoE measurement capable indication. The SN 522 can determine whether the SN and the UE support QoE measurement over a SN interface 502. The SN 522 can send a capable indication of SN configured QoE measurement 504 to the MN 520.

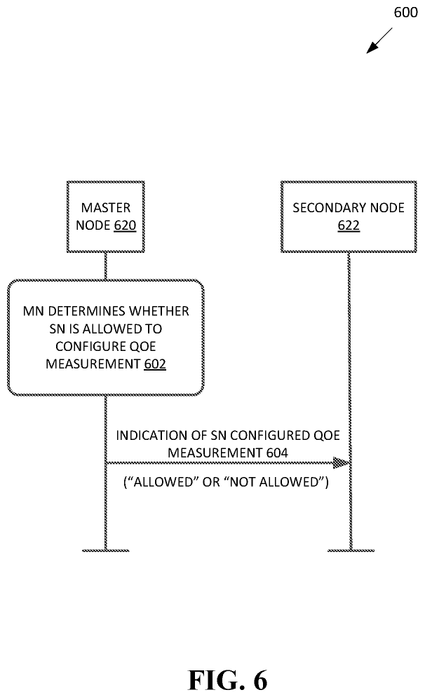

FIG. 6 is an example signaling process 600 for a SN QoE measurement permission indication. The MN 620 can determine whether the SN is allowed to configure QoE measurement 602. The MN 620 can send an indication of SN configured QoE measurement 604 to the SN 622.

Consideration for Power Saving or Network Overload

In case of a specific network scenario (e.g., network overload, UE overheating), the network may trigger a temporary stop of the QoE measurement. The QoE measurement may resume when the situation is relieved.

A network node can send a suspension indication to UE that informs UE that the configured QoE measurement is suspended. After receiving the indication, the UE may not be allowed to deliver QoE measurement report to the network. From UE's perspective, the UE can continue logging the QoE experience information at application layer or suspend the logging behavior. Upon reception of a resume indication from network, the UE can resume the logging behavior if suspended, and deliver the QoE measurement report to network.

In some embodiment, the network can indicate to UE a timer value together with the suspension indication. After receiving the timer value, the UE can start the timer immediately or start the timer when UE stops logging (e.g., logging memory is full, requested service is released). If the UE does not receive QoE measurement resume indication from network before timer expiry, the UE can delete the logged QoE measurement results locally.

In some embodiments, the network node may trigger suspension behavior by receiving the indication from UE. The indication can be included in UE assistance information. The UE can send this indication when UE is overheating or when the UE wants to enable power saving.

In some embodiments, the UE may send indication to network, to ask network to stop QoE measurement. MN may need to forward this indication to SN (or SN to MN).

In some embodiments, the UE may send indication to network, to inform network the QoE measurement is stopped, and optionally include the cause to stop the measurement.

In some embodiments, during intra-RAT handover, the source cell can inform target cell that the UE is configured with QoE measurement, and whether the QoE measurement is suspended or not. In addition to this, the source cell may also forward the QoE measurement configuration to target cell.

In some embodiments, upon inter-RAT handover or inter-system handover, the UE can stop the configured QoE measurement locally, and remove the logged results.

Example Method for QoE Measurement Collection

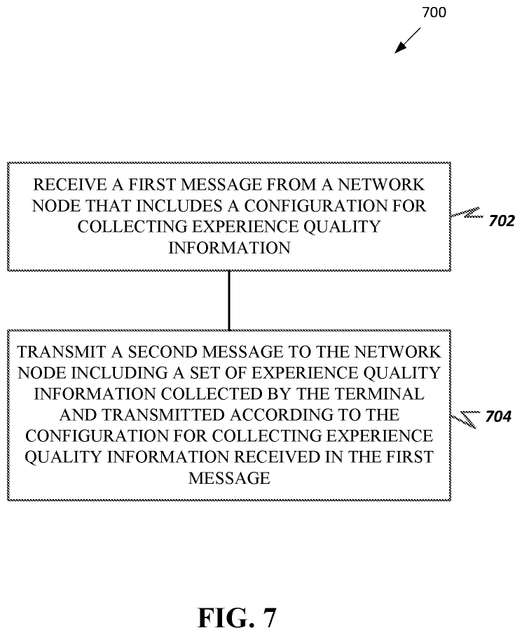

FIG. 7 is a block diagram 700 of an example method for quality of experience (QoE) measurement collection. The method may include receiving a first message from a network node that includes a configuration for collecting experience quality information (block 702).

The method may also include transmitting a second message to the network node including a set of experience quality information collected by the terminal and transmitted according to the configuration for collecting experience quality information received in the first message (block 704)

In some embodiments, the method includes collecting, by the terminal, the set of experience quality information.

In some embodiments, any of the configuration for collecting experience quality information included in the first message or the collected set of experience quality information included in the second message includes quality of service (QoS) information.

In some embodiments, the QoS information includes any of QoS Flow identifier (QFI), protocol data unit (PDU) session identifier, Evolved Universal Terrestrial Access Network (E-UTRAN) Radio Access Bearer identifier (E-RAB ID), and QoS profile information.

In some embodiments, any of the configuration for collecting experience quality information included in the first message or the collected set of experience quality information included in the second message includes network slice identifier.

In some embodiments, any of the configuration for collecting experience quality information included in the first message or the collected set of experience quality information included in the second message includes information identifying target radio access technology (RAT) in which to collect the set of experience quality information.

In some embodiments, the information identifying the target RAT includes any of a cell identity list of at least one RAT or a tracking area code list of at least one RAT or RAT type.

In some embodiments, any of the configuration for collecting experience quality information included in the first message or the collected set of experience quality information included in the second message includes node information that is indicative of target node in which to collect the set of experience quality information.

In some embodiments, any of the configuration for collecting experience quality information included in the first message and the collected set of experience quality information included in the second message includes bearer type indicator indicative of target bearer type for collecting the set of experience quality information.

In some embodiments, the bearer type indicator can be indicative of any of a master cell group (MCG) bearer, a secondary cell group (SCG) bearer, a split bearer, a master node (MN) terminated MCG bearer, a MN terminated SCG bearer, a MN terminated split bearer, a secondary node (SN) terminated MCG bearer, a SN terminated SCG bearer, or a SN terminated split bearer.

In some embodiments, the configuration for collecting experience quality information includes a number of application configuration containers, wherein each application configuration container is applied to a specific RAT.

In some embodiments, collecting the set of experience quality information includes logging a bearer type and time stamp information of the collected service according to the configuration for collecting experience quality information.

In some embodiments, the method includes receiving, by the terminal, multiple configurations for measuring experience quality information from each of a master node (MN) and a secondary node (SN); measuring, by the terminal, a first set of experience quality information when bearer is established over master cell group (MCG) radio interface and a second set of experience quality information when bearer is established over a secondary cell group (SCG) radio interface; and transmitting, by the terminal, a first report to the MN that includes the first set of experience quality information and a second report to the SN that includes the second set of experience quality information.

In some embodiments, the second message is transmitted responsive to the terminal measuring the set of experience quality information.

In some embodiments, the method includes transmitting, by the terminal, an experience quality information indication to the network node indicating that the terminal has collected the set of experience quality information; and receiving, by the terminal, an experience quality information response from the network node, wherein the second message is transmitted by the terminal responsive to receiving the experience quality information response from the network node.

In some embodiments, the method includes transmitting, by the terminal, a 1-bit experience quality information results available indication to the network node indicating that the terminal has measured the set of experience quality information.

In some embodiments, the 1-bit experience quality information results available indication is transmitted to the network node via any of a radio resource control (RRC) reconfiguration complete message, a terminal assistance information message, a RRC setup complete message, and a RRC resume complete message.

In some embodiments, the method includes receiving, by the terminal, an RRC message from the network node that includes a request for the set of experience quality information when a network load is below a threshold level, wherein the terminal transmits the second message to the network node responsive to receiving the RRC message from the network node.

In some embodiments, the method includes receiving, by the terminal, a suspension indication from the network node that includes an indication for the terminal to suspend transmission of the second message and/or stop measuring the set of experience quality information.

In some embodiments, the method includes receiving, by the terminal, a resume indication from the network node, wherein the second message is transmitted by the terminal responsive to receiving the resume indication from the network node.

In some embodiments, the method includes initiating, by the terminal, a timer with a duration indicated in the suspension indication either upon reception of the suspension indication or upon completion of collection of the set of experience quality information; and releasing, by the terminal, the set of experience quality information collected by the terminal when the timer expires.

In some embodiments, the method includes determining, by the terminal, that a power consumption level of the terminal exceeds a threshold power level; and responsive to determining that the power consumption level of the terminal exceeds the threshold power level, transmitting, by the terminal, a power saving message to the network node to initiate a power saving operation, wherein the suspension indication is received by the terminal responsive to transmission of the power saving message.

In another embodiment, a method for wireless communication includes transmitting, by a network node, a first message to a terminal that includes a configuration for collecting experience quality information. The method may also include receiving, by the network node, a second message from the terminal that includes a set of experience quality information collected by the terminal that is transmitted according to the configuration for collecting experience quality information received in the first message.

In some embodiments, the method includes receiving, by the network node, the configuration for collecting experience quality information from a core network node or an operation and maintenance (OAM).

In some embodiments, the method includes forwarding, by the network node, the second message to a QoE collection node.

In some embodiments, the core network node includes any of a Core Access and Mobility Management Function (AMF) node and a Mobility Management Entity (MME) node.

In some embodiments, the method includes forwarding, by the network node, the configuration for collecting experience quality information to a secondary network node, wherein the secondary network node is configured to modify and/or transmit the configuration for collecting experience quality information to the terminal.

In some embodiments, the network node includes a central unit (CU), and wherein the network node transmits the configuration for collecting experience quality information to a distributed unit (CU), wherein the configuration for collecting experience quality information includes any of a requested service type for the set of experience quality information, dedicated radio bearer (DRB) information for the requested service type, and an indication to start, stop, or suspend measuring the set of experience quality information by the terminal.

In some embodiments, the method includes receiving, by the network node, a configuration indication from a secondary network node of whether the network node is capable of configuring the configuration for collecting experience quality information to the terminal.

In some embodiments, the configuration indication is received by the network node responsive to the secondary network node determining that the terminal supports experience quality information measurement and reporting over a radio access technology (RAT) associated with the secondary network node.

In some embodiments, the configuration indication is received by the network node responsive to the secondary network node supporting experience quality information measurement and reporting toward the terminal.

In some embodiments, any of the configuration for collecting experience quality information included in the first message and the measured set of experience quality information included in the second message and the configuration for collecting experience quality information from a core network node includes any of quality of service (QoS) information, a network slice selection identifier, information identifying a target radio access technology (RAT) in which to measure the set of experience quality information, node information that is indicative of a target node in which to measure the set of experience quality information, and a bearer type indicator indicative of a target bearer type in which to measure the set of experience quality information.

In some embodiments, the method includes transmitting, by the network node, one of multiple configurations for measuring experience quality information to the terminal; and receiving, by the network node, a first report from the terminal that includes a first set of experience quality information measured by the terminal when the bearer is established over a master cell group (MCG) radio interface; and/or receiving, by the network node, a second report from the terminal that includes a second set of experience quality information measured by the terminal when the bearer is established over a secondary cell group (SCG) radio interface.

In some embodiments, the method includes receiving, by the network node, an experience quality information indication from the terminal indicating that the terminal has measured the set of experience quality information; and transmitting, by the network node, an experience quality information response to the terminal, wherein the second message is transmitted by the terminal responsive to receiving the experience quality information response from the network node.

In some embodiments, the method includes receiving, by the network node, a 1-bit experience quality information results available indication from the terminal indicating that the terminal has measured the set of experience quality information.

In some embodiments, the 1-bit experience quality information results available indication received by the network node via any of a radio resource control (RRC) reconfiguration complete message, a terminal assistance information message, a RRC setup complete message, and a RRC resume complete message.

In some embodiments, the method includes transmitting, by the network node, an RRC message to the terminal that includes a request for the set of experience quality information when a network load is below a threshold level, wherein the terminal transmits the second message to the network node responsive to receiving the RRC message from the network node.

In some embodiments, the method includes transmitting, by the network node, a suspension indication to the terminal that includes an indication for the terminal to suspend transmission of the second message and/or stop measuring the set of experience quality information.

In some embodiments, the method includes transmitting, by the network node, a resume indication to the terminal, wherein the second message is transmitted by the terminal responsive to receiving the resume indication from the network node.

In some embodiments, the method includes receiving, by the network node, a power saving message from the terminal to initiate a power saving operation responsive to the terminal determining that a power consumption level of the terminal exceeds a threshold power level, wherein the suspension indication is received by the terminal responsive to transmission of the power saving message.

Example Wireless System

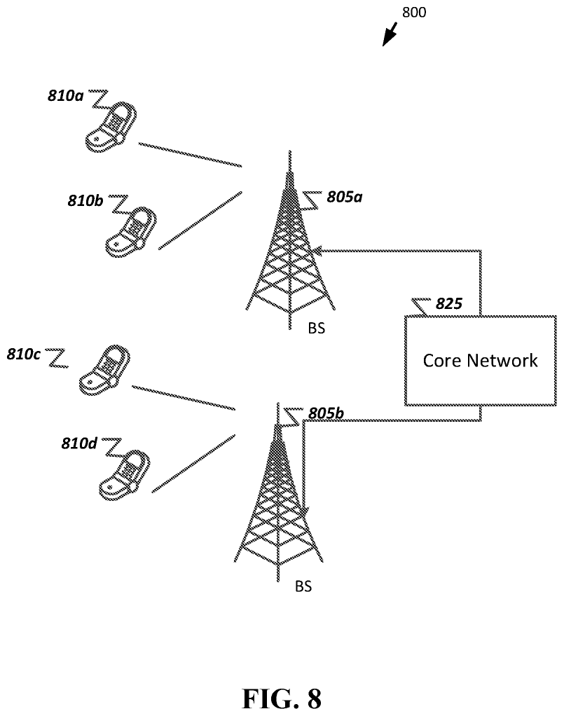

FIG. 8 shows an example of a wireless communication system where techniques in accordance with one or more embodiments of the present technology can be applied. A wireless communication system 800 can include one or more base stations (BSs) 805a, 805b, one or more wireless devices 810a, 810b, 810c, 810d, and a core network 825. A base station 805a, 805b can provide wireless service to wireless devices 810a, 810b, 810c and 810d in one or more wireless sectors. In some implementations, a base station 805a, 805b includes directional antennas to produce two or more directional beams to provide wireless coverage in different sectors.

The core network 825 can communicate with one or more base stations 805a, 805b. The core network 825 provides connectivity with other wireless communication systems and wired communication systems. The core network may include one or more service subscription databases to store information related to the subscribed wireless devices 810a, 810b, 810c, and 810d. A first base station 805a can provide wireless service based on a first radio access technology, whereas a second base station 805b can provide wireless service based on a second radio access technology. The base stations 805a and 805b may be co-located or may be separately installed in the field according to the deployment scenario. The wireless devices 810a, 810b, 810c, and 810d can support multiple different radio access technologies.

In some implementations, a wireless communication system can include multiple networks using different wireless technologies. A dual-mode or multi-mode wireless device includes two or more wireless technologies that could be used to connect to different wireless networks.

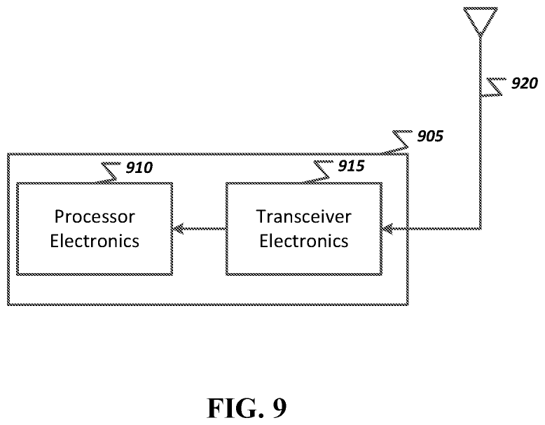

FIG. 9 is a block diagram representation of a portion of a hardware platform. A hardware platform 905 such as a network device or a base station or a wireless device (or UE) can include processor electronics 910 such as a microprocessor that implements one or more of the techniques presented in this document. The hardware platform 905 can include transceiver electronics 915 to send and/or receive wired or wireless signals over one or more communication interfaces such as antenna 920 or a wireline interface. The hardware platform 905 can implement other communication interfaces with defined protocols for transmitting and receiving data. The hardware platform 905 can include one or more memories (not explicitly shown) configured to store information such as data and/or instructions. In some implementations, the processor electronics 910 can include at least a portion of the transceiver electronics 915. In some embodiments, at least some of the disclosed techniques, modules or functions are implemented using the hardware platform 905.

### CONCLUSION

From the foregoing, it will be appreciated that specific embodiments of the presently disclosed technology have been described herein for purposes of illustration, but that various modifications may be made without deviating from the scope of the invention. Accordingly, the presently disclosed technology is not limited except as by the appended claims.

The disclosed and other embodiments, modules and the functional operations described in this document can be implemented in digital electronic circuitry, or in computer software, firmware, or hardware, including the structures disclosed in this document and their structural equivalents, or in combinations of one or more of them. The disclosed and other embodiments can be implemented as one or more computer program products, i.e., one or more modules of computer program instructions encoded on a computer readable medium for execution by, or to control the operation of, data processing apparatus. The computer readable medium can be a machine-readable storage device, a machine-readable storage substrate, a memory device, a composition of matter effecting a machine-readable propagated signal, or a combination of one or more them. The term “data processing apparatus” encompasses all apparatus, devices, and machines for processing data, including by way of example a programmable processor, a computer, or multiple processors or computers. The apparatus can include, in addition to hardware, code that creates an execution environment for the computer program in question, e.g., code that constitutes processor firmware, a protocol stack, a database management system, an operating system, or a combination of one or more of them. A propagated signal is an artificially generated signal, e.g., a machine-generated electrical, optical, or electromagnetic signal, that is generated to encode information for transmission to suitable receiver apparatus.

A computer program (also known as a program, software, software application, script, or code) can be written in any form of programming language, including compiled or interpreted languages, and it can be deployed in any form, including as a stand-alone program or as a module, component, subroutine, or other unit suitable for use in a computing environment. A computer program does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

The processes and logic flows described in this document can be performed by one or more programmable processors executing one or more computer programs to perform functions by operating on input data and generating output. The processes and logic flows can also be performed by, and apparatus can also be implemented as, special purpose logic circuitry, e.g., an FPGA (field programmable gate array) or an ASIC (application specific integrated circuit).

Processors suitable for the execution of a computer program include, by way of example, both general and special purpose microprocessors, and any one or more processors of any kind of digital computer. Generally, a processor will receive instructions and data from a read only memory or a random-access memory or both. The essential elements of a computer are a processor for performing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Computer readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

While this patent document contains many specifics, these should not be construed as limitations on the scope of any invention or of what may be claimed, but rather as descriptions of features that may be specific to particular embodiments of particular inventions. Certain features that are described in this patent document in the context of separate embodiments can also be implemented in combination in a single embodiment. Conversely, various features that are described in the context of a single embodiment can also be implemented in multiple embodiments separately or in any suitable sub combination. Moreover, although features may be described above as acting in certain combinations and even initially claimed as such, one or more features from a claimed combination can in some cases be excised from the combination, and the claimed combination may be directed to a sub combination or variation of a sub combination.

Similarly, while operations are depicted in the drawings in a particular order, this should not be understood as requiring that such operations be performed in the particular order shown or in sequential order, or that all illustrated operations be performed, to achieve desirable results. Moreover, the separation of various system components in the embodiments described in this patent document should not be understood as requiring such separation in all embodiments.

Only a few implementations and examples are described, and other implementations, enhancements and variations can be made based on what is described and illustrated in this patent document.

What is claimed is:

1. A method for wireless communication, comprising:
receiving, by a terminal, a first message from a network node comprising a configuration for collecting experience quality information; and
transmitting, by the terminal, a second message to the network node including a set of experience quality information collected by the terminal and transmitted according to the configuration for collecting experience quality information received in the first message.

2. The method of claim 1, further comprising:
measuring, by the terminal, the set of experience quality information.

3. The method of claim 1, wherein the configuration for collecting experience quality information is included in the first message or the collected set of experience quality information included in the second message includes quality of service (QoS) information.

4. The method of claim 3, wherein the QoS information comprises:
a QoS Flow identifier (QFI),
a protocol data unit (PDU) session identifier,
an Evolved Universal Terrestrial Access Network (E-UTRAN) Radio Access Bearer identifier (E-RAB ID), or
a QoS profile information.

5. The method of claim 1, wherein the configuration for collecting experience quality information included in the first message or the collected set of experience quality information included in the second message includes a network slice identifier.

6. The method of claim 1, wherein the configuration for collecting experience quality information is included in the first message or the collected set of experience quality information included in the second message includes information identifying target radio access technology (RAT) used to collect the set of experience quality information.

7. The method of claim 6, wherein the information identifying the target RAT comprises:
a cell identity list of at least one RAT,
a tracking area code list of at least one RAT, or
a RAT type.

8. The method of claim 1, wherein the configuration for collecting experience quality information included in the first message or the collected set of experience quality information included in the second message includes node information that is indicative of target node in which to collect the set of experience quality information.

9. The method of claim 1, wherein the configuration for collecting experience quality information included in the first message or the collected set of experience quality information included in the second message includes a bearer type indicator indicative of a target bearer type for collecting the set of experience quality information.

10. The method of claim 9, wherein the bearer type indicator is indicative of:
a master cell group (MCG) bearer,
a secondary cell group (SCG) bearer,
a split bearer, a master node (MN) terminated MCG bearer,
a MN terminated SCG bearer,
a MN terminated split bearer,
a secondary node (SN) terminated MCG bearer,
a SN terminated SCG bearer, or
a SN terminated split bearer.

11. The method of claim 1, wherein the configuration for collecting experience quality information includes a number of application configuration containers, wherein each application configuration container is applied to a specific RAT.

12. The method of claim 2, wherein collecting the set of experience quality information includes logging a bearer type and a time stamp information of the collected service according to the configuration for collecting experience quality information.

13. The method of claim 1, further comprising:
receiving, by the terminal, multiple configurations for measuring experience quality information from each of a master node (MN) and a secondary node (SN);
measuring, by the terminal, a first set of experience quality information when a bearer is established over a master cell group (MCG) radio interface and a second set of experience quality information when the bearer is established over a secondary cell group (SCG) radio interface; and
transmitting, by the terminal, a first report to the MN comprising the first set of experience quality information and a second report to the SN comprising the second set of experience quality information.

14. The method of claim 1, wherein the second message is transmitted responsive to the terminal measuring the set of experience quality information.

15. The method of claim 1, further comprising:
transmitting, by the terminal, an experience quality information indication to the network node indicating that the terminal has collected the set of experience quality information; and
receiving, by the terminal, an experience quality information response from the network node, wherein the second message is transmitted by the terminal responsive to receiving the experience quality information response from the network node.

16. The method of claim 1, further comprising:
transmitting, by the terminal, a 1-bit experience quality information result available indication to the network node indicating that the terminal has measured the set of experience quality information.

17. The method of claim 16, wherein the 1-bit experience quality information result available indication is transmitted to the network node via any of:
a radio resource control (RRC) reconfiguration complete message,
a terminal assistance information message,
an RRC setup complete message, or
an RRC resume complete message.

18. The method of claim 17, further comprising:
receiving, by the terminal, an RRC message from the network node comprising a request for the set of experience quality information when a network load is below a threshold level, wherein the terminal transmits the second message to the network node responsive to receiving the RRC message from the network node.

19. The method of claim 1, further comprising:
receiving, by the terminal, a suspension indication from the network node comprising an indication for the terminal to suspend transmission of the second message, or to stop measuring the set of experience quality information.

20. The method of claim 19, further comprising:
receiving, by the terminal, a resume indication from the network node, wherein the second message is transmitted by the terminal responsive to receiving the resume indication from the network node.
